(19) United States
(12) Patent Application Publication
(10) Pub. No.: US 2004/0255888 A1
(43) Pub. Date: Dec. 23, 2004

(54) Spark discharging device

(76) Inventor: Matthew J. Tuohy, Kent, WA (US)

Correspondence Address: PERKINS COIE LLP, PATENT-SEA, P.O. BOX 1247, SEATTLE, WA, 98111-1247, US

(21) Appl. No.: 10/801,100

(22) Filed: Mar. 15, 2004

Related U.S. Application Data
(60) Provisional application No. 60/455,494, filed on Mar. 17, 2003.

(51) Int. Cl. F02P 15/00; F23Q 5/00

(52) U.S. Cl. 123/154; 361/255

(57) ABSTRACT

A spark discharging device that sparks on the closing of contacts carrying high current. In one embodiment, a capacitor is discharged to provide a short pulse of high current upon making contact between one movable electrode to the capacitor and a ground electrode. A solenoid coil energized from the engine's electrical system is operated in synchronism with the movement of the engine's piston. A solenoid drives a plunger and movable electrode tipped with a contact portion so the contact portion moves into engagement with a ground electrode connected to the return circuit. The movable electrode is coupled to the charged capacitor located within or external to the spark discharger housing. It is emphasized that this abstract is provided to comply with the rules requiring an abstract. It is submitted with the understanding that it will not be used to interpret or limit the scope or meaning of the claims (37 C.F.R. 1.72(b)).

### CROSS-REFERENCE TO RELATED APPLICATION(S)

This application claims the benefit of U.S. Provisional Application No. 60/455,494 filed on Mar. 17, 2003, which application is incorporated by reference in its entirety.

### TECHNICAL FIELD

This invention relates to spark-discharging devices, such as spark plugs or igniters utilizing the spark discharged when a circuit carrying current is closed.

A spark-discharging device is provided for an engine or other uses where a fuel or other gasses are to be ignited. The spark-discharging device comprising of a contact set within the engine combustion chamber and suitable operating means to close the contacts, thereby discharging a capacitor and creating an arc at a grounding electrode.

### BACKGROUND

All ignition systems use spark plugs for engines that utilize a high voltage spark bridging a gap in a spark plug. The general prior art ignition systems use a transformer where a winding carrying current which in turn creates a magnetic field. When the current is interrupted, the magnetic field collapses and a voltage is generated across the primary winding and, if present, a secondary winding of many turns. In automotive use, such an arrangement produces in excess of 20,000 volts in a pulse of short duration across a spark plug gap. The resulting spark jumping across the gap ignites the fuel or other gasses in an engine combustion chamber. Early spark systems put the interrupter contacts within the engine combustion chambers, so when they were separated, the voltage generated by the coil (kick back voltage) was immediately available to jump the widening spark gap. Such a simple arrangement produced a short weak spark. Even so, on Jul. 25, 1989, Inventor Max Pasbrig discloses in U.S. Pat. No. 4,850,316 a solenoid driven break-type spark plug utilizing the inductance of the solenoid to produce the high voltage pulse. U.S. Pat. No. 4,850,316 is the last of a series of patents by Mr. Pasbrig on the subject. His patents U.S. Pat. Nos. 3,693,607, 3,908,146, 4,172,439 and 4,509,469 all are arrangements of solenoids to break a circuit within an engine combustion chamber, thereby creating a spark.

Pasbrig '316 moves the electrodes transverse to the axis of the cylinder, and the others use axial travel of a solenoid plunger.

J. M. Wilson in U.S. Pat. No. 735,923, Aug. 11, 1903 utilizes a fixed electromagnet and break points in series. This is the physical and electrical of a “buzzer” device and Mr. Wilson's sparker will spark repeatedly during the interval that the engine-coordinated breaker is closed. A buzzer arrangement sparks on opening of the contacts. Mr. Wilson's '923 disclosure further comprises that the buzzer contacts are part of a form C, i.e., single pole, double throw, switch assembly.

In general, for all breaker points in series with an inductor/high-voltage coil, whether the inductor-coil be a component of a solenoid, or specifically designed primarily to provide inductance, the spark starts as the signal-breaker points open and may continue for some time as the signal-breaker points close or signal time is ended. The arrangement inherently produces a short and fairly weak spark. There is a need for a more reliable ignition method in very high performance engines such as used for automobile racing and the like.

### SUMMARY

The present invention overcomes drawbacks experienced in the prior art.

The present invention provides additional advantages, but unlike breaking contact embodiments that rely on the discharge of energy from magnetic circuits, the present invention sparks on the closing of contacts carrying high current. Under one aspect of the invention, the spark discharging device sparks on the closing of contacts carrying high current, which is unlike breaking contact embodiments that rely on the discharge of energy from magnetic circuits. In one embodiment, a capacitor is discharged to provide a short pulse of high current upon making contact between one movable electrode coupled to the capacitor and a ground electrode. This closing of a high current circuit is accompanied by a sizeable flash of metal rich ions spattering away from the source, such that the resulting spark comprises a much larger flame front to ignite the fuel or other gasses.

In one embodiment, a solenoid coil energized from the engine's electrical system is operated in synchronism with the movement of the engine's piston. The solenoid drives a plunger and movable electrode tipped with contact portion so the contact portion moves into engagement with a ground electrode connected to the return circuit. The movable electrode is coupled to a charged capacitor located within or external to the spark discharger housing. Upon contact, a current surge of perhaps as much as several hundred amperes flows and causes a spark or flash of metal ions to be released from the engaged electrodes, thereby being able to ignite fuel or other gasses within the engine's combustion chamber or cylinder head. After contact and creation of the spark, the combined forces return the moving electrode to start position, such as from a return spring and the pressure of the gas ignited in the combustion chamber or cylinder head, or reversed polarity solenoid.

### BRIEF DESCRIPTION OF THE DRAWINGS

FIG. 1 is a cut-away view of the spark discharging device in accordance with one embodiment of the invention.

FIG. 2 is an illustrative wiring circuit showing capacitive and electrical signal circuit paths.

FIG. 3 is an enlarged, partial cross-sectional view of an alternate embodiment of a replaceable grounding electrode.

FIG. 4 is schematic view of an alternate embodiment of the present invention.

### DETAILED DESCRIPTION

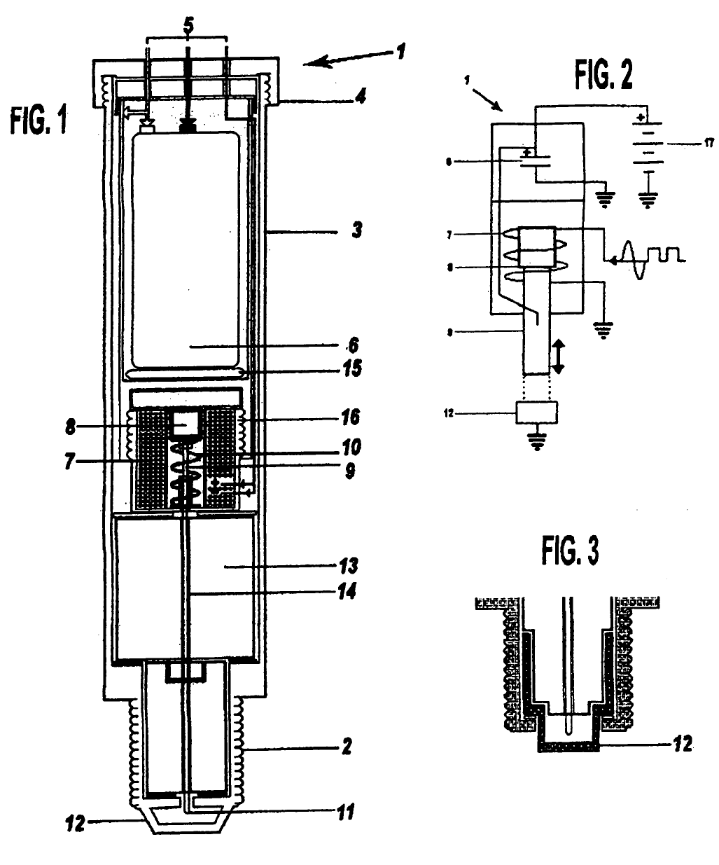

A spark-discharging device, such as a spark plug for an engine in accordance with one embodiment of the invention is shown in FIG. 1 as item 1. The outer case assembly comprises an engine mounting adaptation 2 in the form of a screw plug adapted to screw into an engine cylinder head, main housing 3, cover 4, and capacitor and signal Input terminals 5, with contact means for supplying a charge to the capacitor 6 within. Internal wiring and a connection terminal are provided that connect to one or both ends of the solenoid coil 7. Many ways of leading the electrical wiring out of the housing are possible. One is to have a contact on the underside of the cover 4, and a terminal post passing through the cover 4, in a manner similar to the showing at terminal 5. Terminal 5 may be co-axial and provide removable termination simultaneously for both the capacitor and the solenoid. Both the capacitor and coil may utilize the case and engine as return conductors to complete the circuit.

The spark plug 1 of the illustrated embodiment includes the solenoid coil 7 configured to move an actuator 8, which is connected to an electrode rod 9 having a distal electrode tip 11. The electrode rod 9 and electrode tip 11 move axially relative to a grounding electrode 12, thereby providing a pair of electrical contacts through which the capacitor 6 discharges with the production of plasma spark when contact is made between the two electrodes. In the illustrated embodiment, the grounding electrode 12 is integrally connected to the engine mounting adaptation 2 (such as the threaded bottom portion of the main housing). (In an alternate embodiment, FIG. 3, the grounding electrode 12 can be a removable member connected to a receiving portion on the main housing 3, positionable within the engine combustion chamber or cylinder head).

Guide block 13 is an insulator with a guide bore hole 14 for supporting and guiding the electrode rod 9 as it moves relative to the grounding electrode. Guide block 13 of one embodiment is constructed of an electrically insulating material, such as a ceramic compound, although other materials can be used. In general, electrical insulators are also poor heat conductors. Dielectrics types or porcelain like material may be employed to enhance the thermal insulation properties of the guide block. The lower end of the guide block 13 may be a material with higher thermal conductivity to drain away heat from the electrode rod.

The actuator 8 is comprised of magnetic material and can be laminated or otherwise treated to prevent eddy-currents from forming within. The material of ceramic magnets can be both magnetic and insulating. The actuator 8 may carry a permanent magnetic charge, or may be unmagnetized.

The solenoid coil 7 is switched on, current builds and EMF forces act upon the actuator 8, therefore moving the electrode rod 9 to the grounding electrode 12. Contact is made between the electrode rod 9 and the grounding electrode 12, thereby instantly discharging the capacitor 6 and the spark is developed. The solenoid coil 7 is then interrupted by external means (switched off) and a return spring 10 pushes against the actuator 8 (also aided by cylinder pressure) so as to return the actuator 8 and the electrode rod 9 back to start position.

The spark-discharge device 1 is then ready to generate another spark upon charging of the capacitor 6, activation of the solenoid coil, and moving the electrode into contact with each other again.

Referring to FIG. 2, it is seen that the capacitor 6 is charged between operations from a DC voltage source 17, and that the solenoid 7 is energized by external signal/voltage.

The spark plug 1 of one embodiment is constructed as described and shown in FIG. 1, wired as shown in FIG. 2. The spark plug 1 disclosed herein can include structure adapted to receive tools to install/remove and assemble/disassemble the device. In general, these will be a combination of gripping surfaces such as knurling or polygon shapes adapted for receiving a wrench or pliers, whereby forces may be applied to operate the assembly and installing means provided. The disclosure herein shows the spark plug assembly utilizing cooperating screw threads to fasten and unfasten the connecting various parts, although other attaching devices may be used.

The embodiment described utilizes a plunging electrode rod of the selected contact material. The tip of the rod can be the preferred material while the rest of the rod can be another selected conductive material.

The embodiment described, utilizes a simple co-axial solenoid to provide the EMF electro motive force for moving the contact elements together. Other arrangements of magnetic driven motors are practical, and so are a variety of other motor means.

Pole pieces and other elements in the magnetic circuit are not used in the embodiment illustrated, but the addition of pole pieces and low-reluctance elements in the magnetic path to enhance the magnetic forces could be included. Electrostatic and piezoelectric actuators could also be used. Mechanical arrangements such as cams and pushrods, pneumatic, hydraulic actuators, and even operating the contacts by the rising of the piston are reasonable variants substituting for embodiment described.

The sealing means shown consists of metal or other high temperature O-rings. Labyrinth seals are anticipated, as is sealing simply by close fit along a long seal-path.

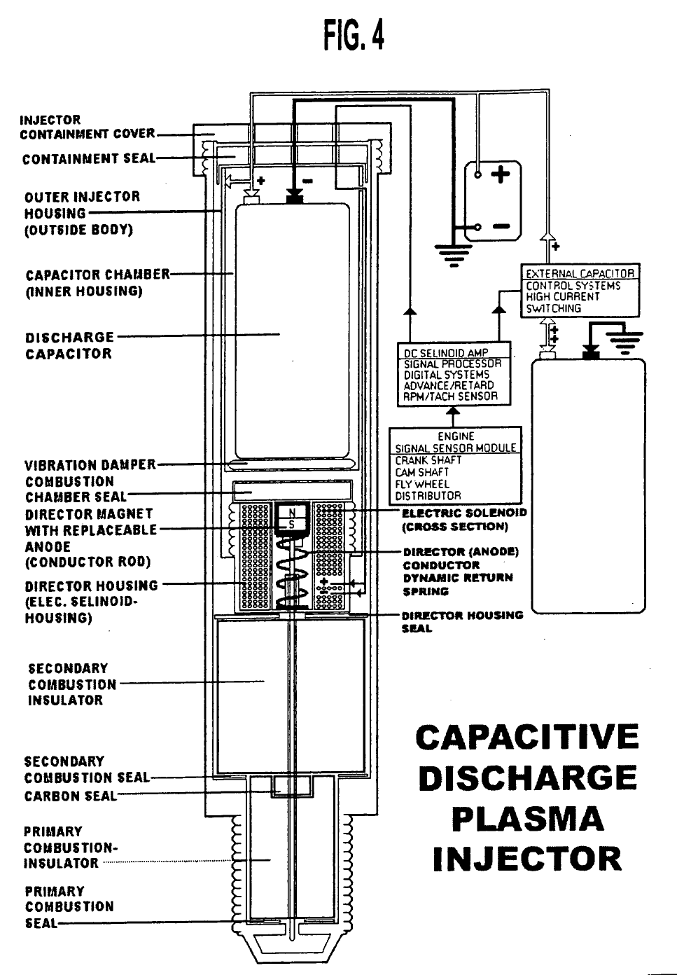

FIG. 4 is an alternative embodiment of the spark-discharging device, FIG. 1, with a plurality of seals illustrated between components. Features of the spark-discharging device are labeled in FIG. 4 in a self-explanatory manner as will be understood by one skilled in the relevant art. The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention as defined by the claims which follow.

I claim:

1. A spark-discharging device for an engine or other uses where a fuel or other gases are to be ignited comprising of a contact set including a movable electrode and ground electrode positionable within the engine combustion chamber and suitable operating mechanism to close the contact set, thereby discharging a capacitor coupled to and creating a spark upon engagement of the contact set.
